(19) United States
(12) Patent Application Publication
(10) Pub. No.: US 2021/0177140 A1
(43) Pub. Date: Jun. 17, 2021

(54) HANGER BAR

(71) Applicant: World Wide Stationery Mfg. Co., Ltd., Kwai Chung, New Territory (CN)

(72) Inventor: Chun Yuen To, N.T. Hong Kong (CN)

(21) Appl. No.: 16/063,129

(22) PCT Filed: Apr. 17, 2018
(86) PCT No.: PCT/CN2018/083358

§ 371 Date: Jun. 15, 2018

(51) Int. Cl. A47B 63/06; A47B 96/14

(52) U.S. Cl. CPC A47B 63/06; A47B 96/1441

(57) ABSTRACT

A hanger bar for mounting a hanging file folder on a pair of support rails includes a body having a top, a bottom, and opposite longitudinal ends. The body includes a first section having a length extending longitudinally across the body and a height extending from the top of the body toward the bottom of the body. A second section has a length extending longitudinally across the body and a height extending from the first section of the body toward the bottom of the body. A third section has a length extending longitudinally across the body and a height extending from the second section of the body to the bottom of the body. The first section is angled with respect to a vertical axis when the body is positioned in a vertical orientation.

### CROSS REFERENCE TO RELATED APPLICATION

This application is a US National Stage Application of International Application No. PCT/CN2018/083358, filed Apr. 17, 2018, the entire content of which is hereby incorporated by reference.

### FIELD OF THE INVENTION

The present invention relates generally to hanging file folders, and more particularly to a hanger bar for a hanging file folder.

### BACKGROUND

Hanging file folders are commonly used for storing and organizing papers in storage units such as file cabinets and drawers. Sleeves may be provided in the folder's top edges through which hanger bars or rods are received. The ends of the bars are exposed and may be notched to enable the bars to engage and be retained on rails within the storage unit. The bars are of sufficient length to span the distance between the support rails. Therefore, in use, the bars are hooked over the support rails so that the file folder is suspended therefrom enabling the file folder to hang on the rails within the storage unit.

### SUMMARY

In one aspect, a hanger bar for mounting a hanging file folder on a pair of support rails generally comprises a body having a top, a bottom, and opposite longitudinal ends. The body includes a first section having a length extending longitudinally across the body and a height extending from the top of the body toward the bottom of the body. A second section has a length extending longitudinally across the body and a height extending from the first section of the body toward the bottom of the body. A third section has a length extending longitudinally across the body and a height extending from the second section of the body to the bottom of the body. The first section is angled with respect to a vertical axis when the body is positioned in a vertical orientation.

In another aspect, a hanger bar for mounting a hanging file folder on a pair of support rails generally comprises a body having a top, a bottom, and opposite longitudinal ends. A pair of hooks are formed in the bottom of the body. Each hook is configured for receiving a respective support rail to mount the hanger bar on the support rails. A first hook is formed proximate a first longitudinal end of the body and a second hook being formed proximate a second longitudinal end of the body opposite the first longitudinal end of the body. Portions of the hooks formed for engaging the support rails are blunt to facilitate sliding of the hanger bar along the support rails.

In yet another aspect, a hanger bar for mounting a hanging file folder on a pair of support rails generally comprises a body having a top, a bottom, and opposite longitudinal ends. The body includes a first section having a length extending longitudinally across the body and a height extending from the top of the body toward the bottom of the body. A second section has a length extending longitudinally across the body and a height extending from the first section of the body toward the bottom of the body. A third section has a length extending longitudinally across the body and a height extending from the second section of the body to the bottom of the body. The first, second, and third sections are each planar.

Other objects and features will be in part apparent and in part pointed out hereinafter.

### BRIEF DESCRIPTION OF THE DRAWINGS

FIG. 1 is a perspective of a hanging file folder system;

FIG. 2 is an enlarged fragmentary view of the hanging file folder system of FIG. 1;

FIG. 3 is a front, fragmentary perspective of a hanger bar of the hanging file folder system;

FIG. 4 is a rear, fragmentary perspective of the hanger bar;

FIG. 5 is a front, fragmentary view of the hanger bar;

FIG. 6 is a rear, fragmentary view of the hanger bar;

FIG. 7 is an enlarged fragmentary view of the hanger bar of FIG. 3;

FIG. 8 is an enlarged fragmentary view of the hanger bar of FIG. 4;

FIG. 9 is a vertical section of the hanger bar taken through a middle section of the hanger bar;

FIG. 10 is a vertical section of the hanger bar taken through a hook of the hanger bar;

FIG. 11 is a cross section of the hanger bar taken through line 11-11 of FIG. 6; and

FIG. 12 is a cross section of the hanger bar taken through line 12-12 of FIG. 6.

Corresponding reference characters indicate corresponding parts throughout the drawings.

### DETAILED DESCRIPTION

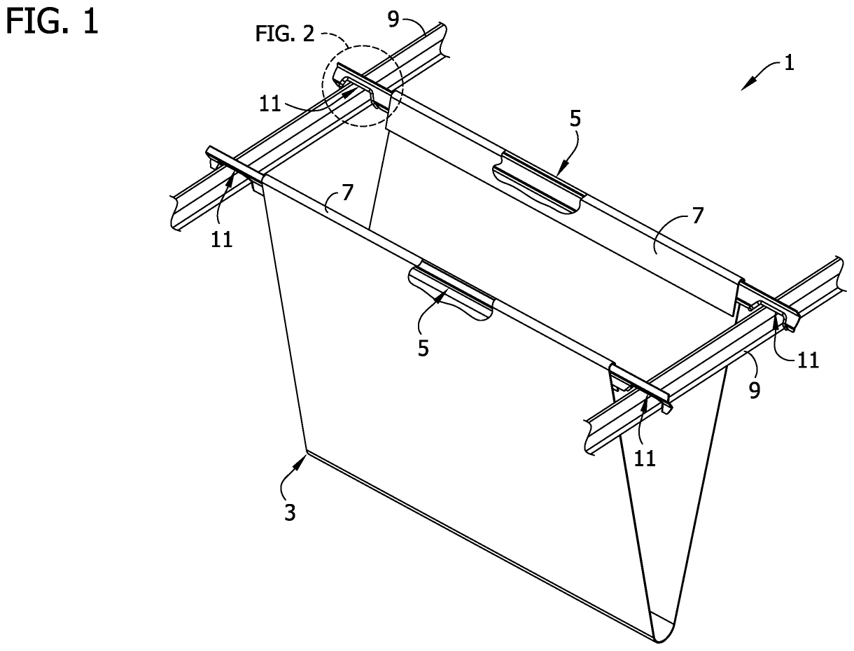

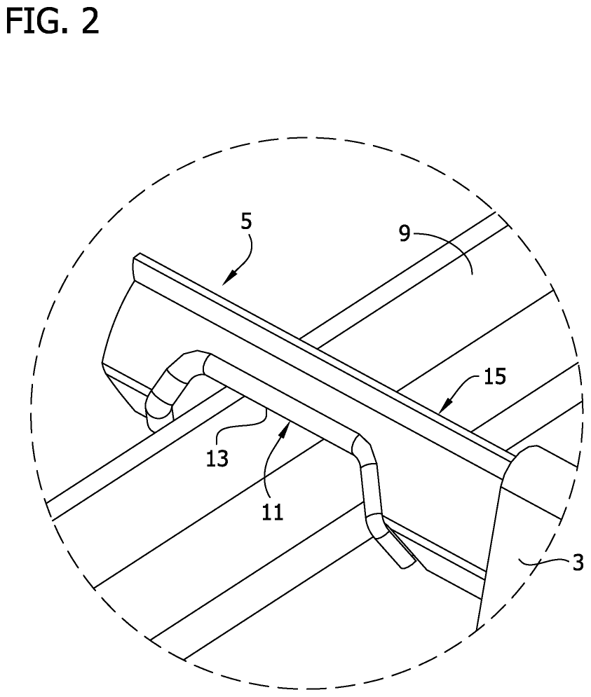

Referring to FIGS. 1 and 2, a hanging file folder system is generally designated at 1. The system comprises a hanging file folder 3 and a pair of hanger bars 5 received in respective folds 7 of the hanging file folder for mounting the hanging file folder on a pair of support rails 9 in a filing cabinet drawer (not shown). In one embodiment, the hanger bars 5 are formed from metal. The hanger bars 5 are configured to slideably mount the hanging file holder 3 on the rails 9 for moving the hanging file folder along the rails and for opening and closing the hanging file folder on the rails. The hanger bars 5 include hooks 11 at opposite longitudinal ends of the hanger bars which receive a respective support rail 9 to mount and retain the hanging file holder 3 on the support rails. Each hook 11 has a blunt engagement surface 13 to facilitate sliding of the hanger bars 5 along the support rails 9. The rounded configuration of the surface 13 of the hooks 11 also reinforces the hanger bars 5 at the hooks to strengthen the hanger bars.

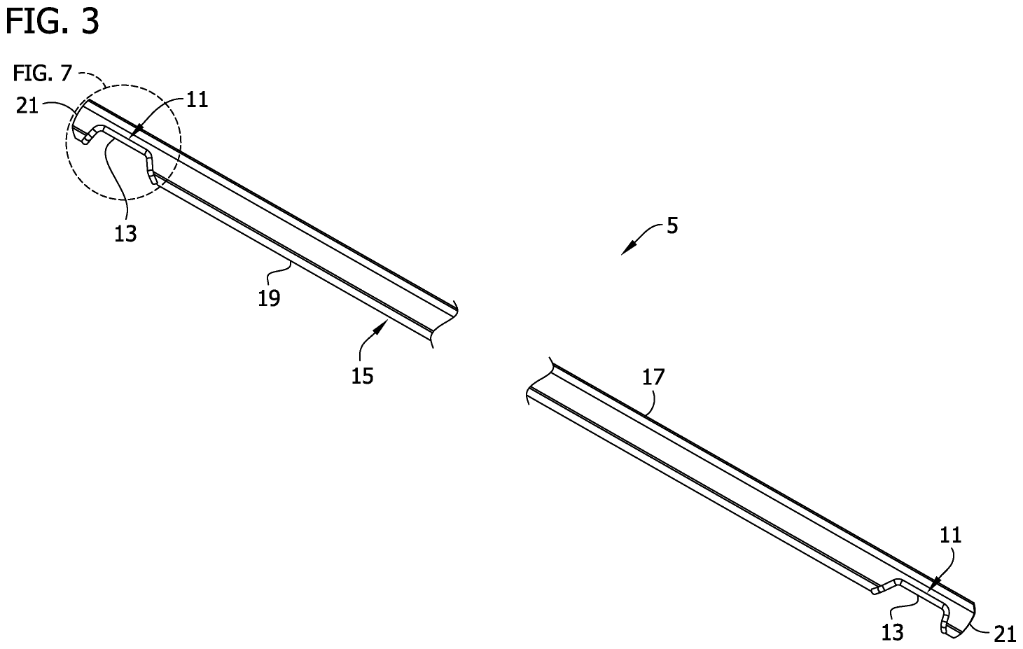

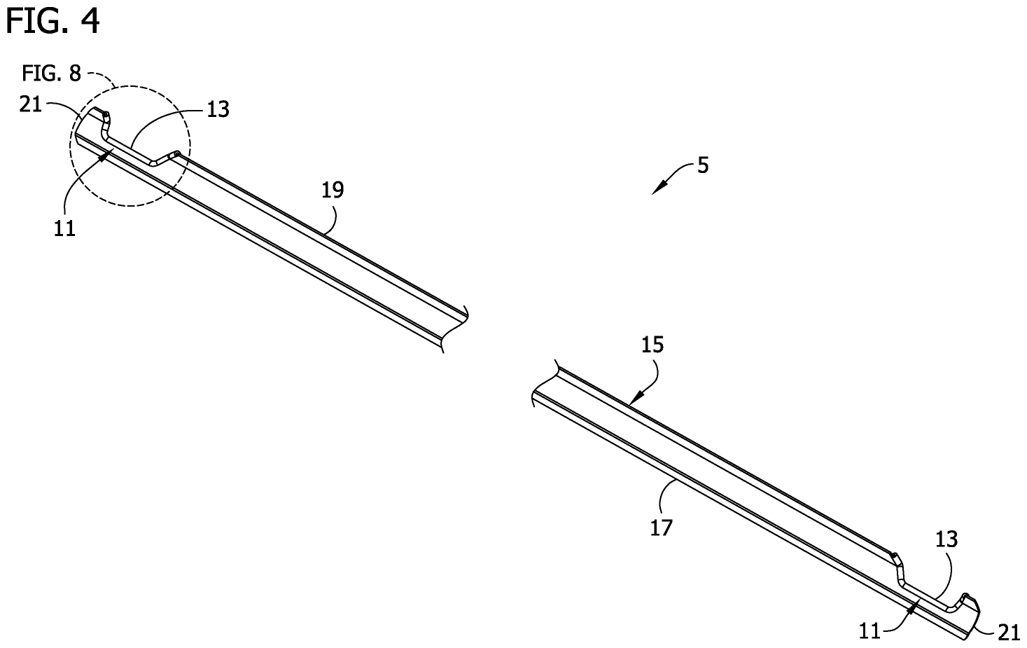

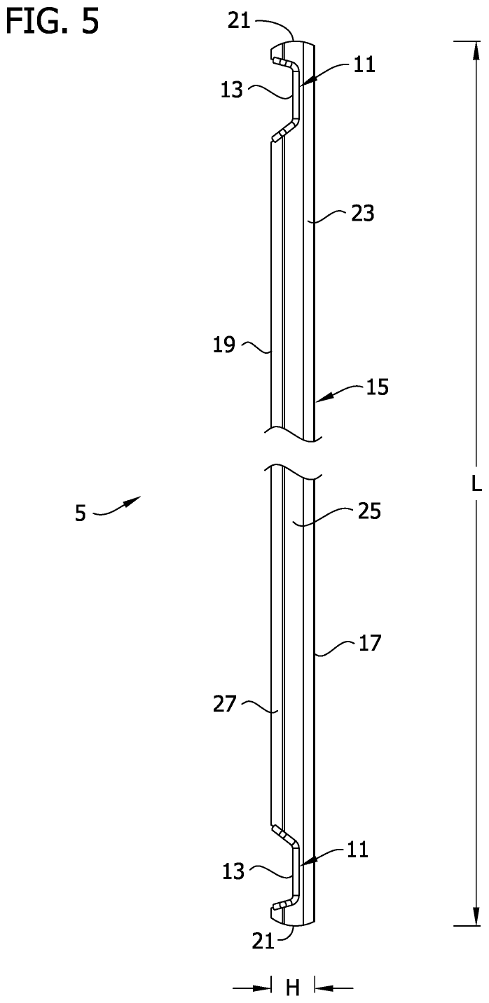

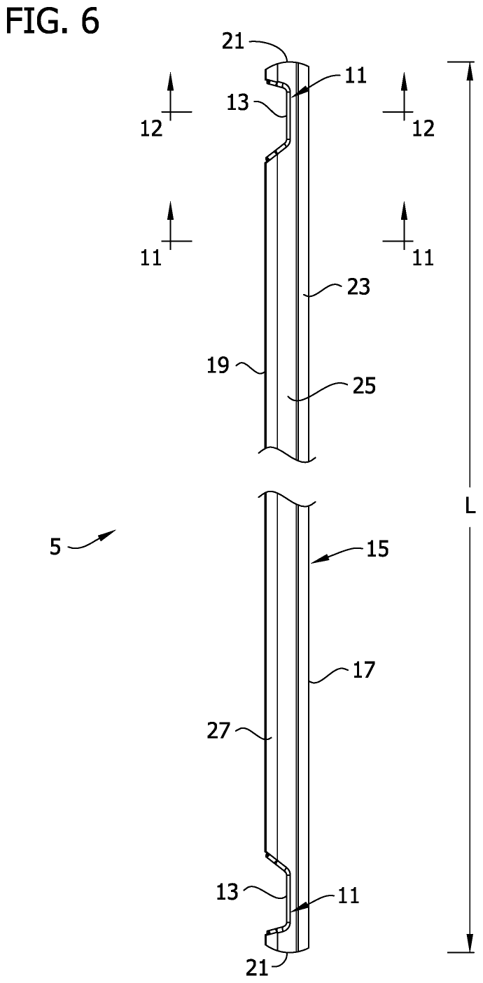

Referring to FIGS. 3-6 and 9, each hanger bar 5 comprises a body 15 including a top edge 17, a bottom edge 19, and opposite longitudinal ends 21. A length L of the body 15 extends between the longitudinal ends 21. A height H of the body 15 extends between the top edge 17 and bottom edge 19. The body 15 can be of sheet metal formed to include a first section 23, a second section 25, and a third section 27 each extending longitudinally across the body 15 between the longitudinal ends 21. As seen in the figures, the hooks 11 formed in the body 15 form a discontinuity in a portion of the second and third sections 25, 27 of the body. However, it will be understood that the sections generally extend between the longitudinal ends 21. At least a portion of the second section 25 extends continuously between the longitudinal ends 21. An entirety of the first section 23 extends continuously between the longitudinal ends 21.

The first section 23 is disposed at the top of the body 15 when the hanger bar 5 is in use such that a height H₁ extends perpendicularly to the longitudinal axis of the body from the top edge 17 to the second section 25. The second section is disposed in the middle of the body 15 and has a height H₂ that extends perpendicularly from the longitudinal axis of the body from the first section 23 to the third section 27. The third section is disposed at a bottom of the body 15 and has a height H₃ that extends perpendicularly to the longitudinal axis of the body from the second section 25 to bottom edge 19. In the illustrated embodiment, the second section 25 extends directly from the first section 23, and the third section extends 27 extends directly from the second section. However, additional sections could be included between the first section 23 and the second section 25 and between the second section and the third section 27 without departing from the scope of the disclosure.

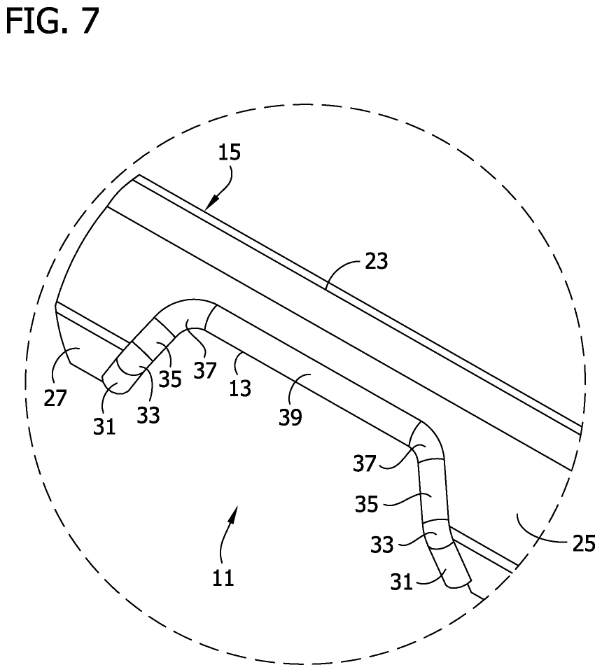

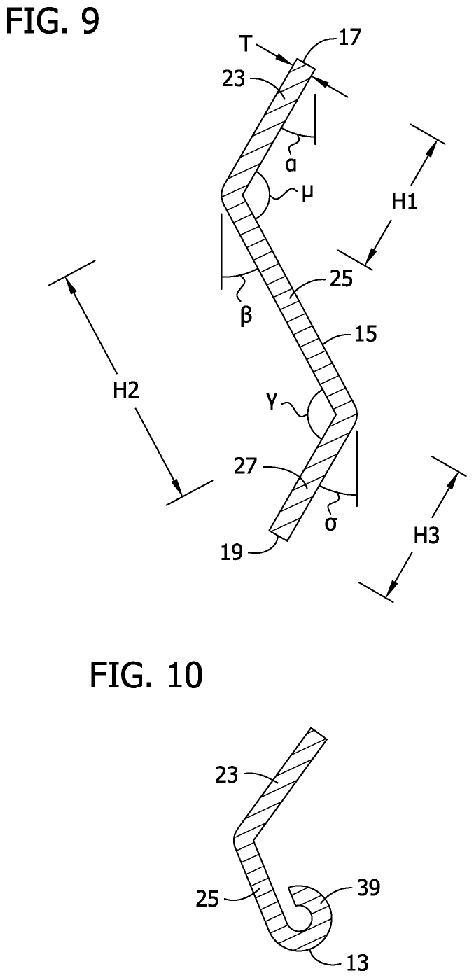

Referring to FIG. 9, each section 23, 25, 27 comprises a planar section of the body 15. A thickness T of the body 15 may be the same for each of the first, second, and third sections 23, 25, 27. The thickness T of the body 15 may be between about 0.25 mm (about 0.01 inches) and about 0.45 mm (about 0.02 inches). In one embodiment, the thickness of the body 15 may be less than about 0.5 mm (about 0.02 inches). When the body 15 of the hanger 5 is positioned in a vertical orientation, a height H1 of the first section 23 extends at an angle to a vertical plane. In one embodiment, the height H1 of the first section 23 is between about 2 mm (about 0.08 inches) and about 3.5 mm (about 0.14 inches.) A vertical orientation of the body 15 may be defined as a position of the body where a bottommost portion of horizontal segment 39 (FIGS. 7 and 10) of the hook 11 is oriented to face a horizontal plane. The section of FIG. 9 shows the body 15 in the vertical orientation. This is the position the hanger bar 5 will assume when in use as shown in FIG. 1.

In this orientation, the first section 23 extends at an angle α to a vertical axis. The first section 23 may extend at an angle α from about 20 degrees to about 40 degrees from vertical. A height H2 of the second section 25 extends at an angle β to a vertical axis and at an angle μ to the first section 23. In one embodiment, the height H2 of the second section 25 is between about 2.5 mm (about 0.1 inches) and about 4.5 mm (about 0.18 inches). The second section 25 may extend at an angle β from about 20 degrees to about 40 degrees from vertical, and at an angle μ from about 110 degrees to about 130 degrees from the first section 23. A height H3 of the third section 27 extends at an angle σ to a vertical axis and at an angle γ to the second section 25. In one embodiment, the height H3 of the third section 27 is between about 2.0 mm (about 0.08 inches) and about 3.5 mm (about 0.14 inches). The third section 27 may extend at an angle σ from about 20 degrees to about 40 degrees from vertical, and at an angle γ from about 110 degrees to about 130 degrees from the second section 25.

The angles of extension of the first and third sections 23, 27 of the body 15 are preferably such that the first and third sections extend generally parallel to each other. However, the first and third sections 23, 27 could extend at non-parallel angles without departing from the scope of the disclosure. The angled configuration of the sections 23, 25, 27 strengthens the body 15 of the hanger bar 5 as compared to a hanger bar having a single vertical or multiple vertical sections. As a result, the thickness T of the body 15 can remain relatively small while maintaining sufficient strength for providing the structural support for the hanging file holder 3 while bearing the weight of the files received in the file folder.

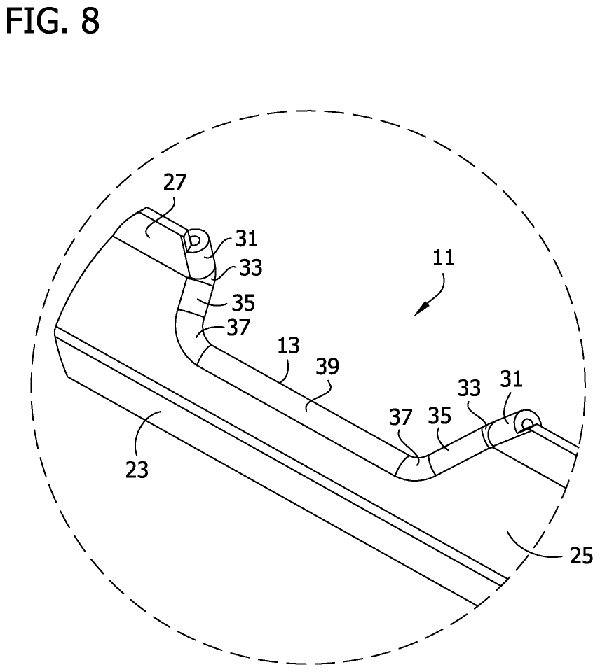

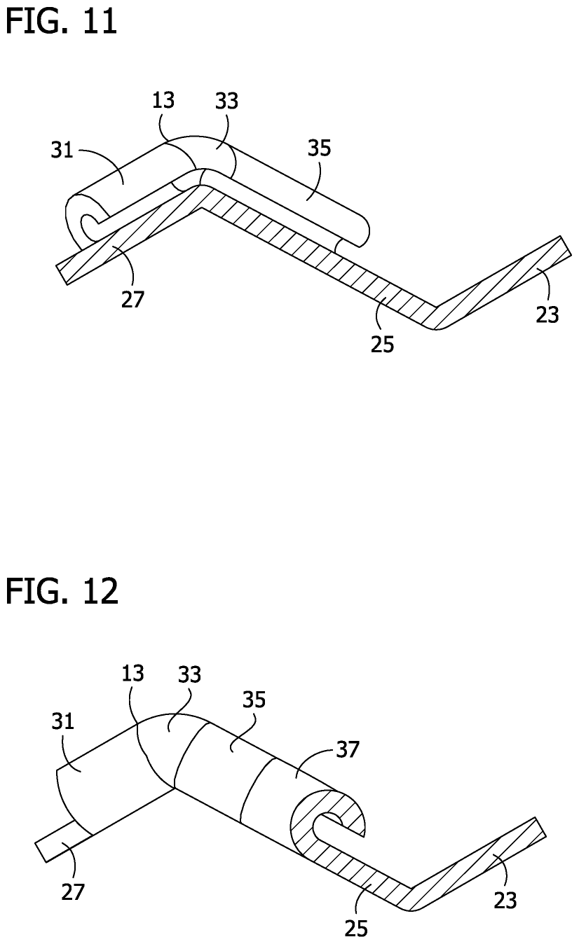

Referring to FIGS. 7, 8, and 10-12, the hooks 11 on the hanger bar 5 are defined by cutouts or notches in the body 15 near the longitudinal ends 21. The cutout extends completely through the height of third section 27 and partly through the height of second section 25. The portion of the body 15 that defines the hook 11 is rolled in a rearward direction toward a back of the body to define the blunt engagement surface 13. Thus, material of the body 15 is bent out of plane with respect to an adjacent portion of the body forming a curved segment that extends along the hook 11. It will be understood that the body 15 may be formed other than by bending sheet metal without departing from the scope of the present invention.

Because the hook 11 is formed in the material of the body 15, the engagement surface 13 includes segments which correspond with the second and third sections 25, 27 of the body. As such, first segments 31 correspond to the third section 27 of the body 15. Bends 33 extend from respective first segments 31 and correspond to the angle γ formed between the second and third sections 25, 27 of the body 15. Second segments 35 of the engagement surface 13 correspond to the second section 25 of the body 15. Bends 37 extend from respective second segments 35.

A third segment 39 defines a horizontal segment of the engagement surface 13. The third segment 39 extends within the second section 25 of the body 15. Each of the segments and bends 31-39 is rolled so that the entire engagement surface 13 has a rounded configuration which facilitates sliding the hanger bar 5 along the rails 9. This also eliminates the need to apply a coating over the hooks 11 to provide the smooth surface for engaging the rails 9. Therefore, the metal material of the hanger bar 5 which defines the hooks 11 is configured to directly engage the support rails 9 when the hanger bar is mounted on the support rails. Thus, the hanger bar 5 including the support rail engaging hooks 11 is formed from a single piece of material. The rounded configuration of the hooks 11 also reinforces the hooks to strengthen the area of the hanger bar 5 that engages the rails 9. The result is a hanger bar 5 formed from a single piece of thin sheet metal having a body 15 with the strength and rigidity to support the hanging file folder 3, and any files held in the file folder, and reinforced hooks 11 configured to easily slide along the support rails 9 in a filing cabinet drawer.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above apparatuses, systems, and methods without departing from the scope of the invention, it is intended that all matter contained in the above description and shown in the accompanying drawings shall be interpreted as illustrative and not in a limiting sense.

What is claimed is:

1. A hanger bar for mounting a hanging file folder on a pair of support rails, the hanger bar comprising a body having a top, a bottom, and opposite longitudinal ends, the body including a first section having a length extending longitudinally across the body and a height extending from the top of the body toward the bottom of the body, a second section having a length extending longitudinally across the body and a height extending from the first section of the body toward the bottom of the body, and a third section having a length extending longitudinally across the body and a height extending from the second section of the body to the bottom of the body, the first section being angled with respect to a vertical axis when the body is positioned in a vertical orientation.

2. The hanger bar of claim 1, wherein each of the first, second, and third sections are angled with respect to the vertical axis when the body is positioned in a vertical orientation.

3. The hanger bar of claim 1, wherein the second section is angled from the first section at an angle of between about 110 degrees and about 130 degrees.

4. The hanger bar of claim 3, wherein third section is angled from the second section at an angle of between about 110 degrees and about 130 degrees.

5. The hanger bar of claim 1, wherein the first, second, and third sections are each planar.

6. The hanger bar of claim 5, wherein the first, second, and third sections each have a thickness of less than about 0.5 mm (0.02 inches).

7. The hanger bar of claim 1, wherein the first section is generally parallel to the third section.

8. The hanger bar of claim 1, wherein the height of the second section is greater than the height of the first and third sections.

9. The hanger bar of claim 8, wherein the height of the third section is greater than the height of the first section.

10. The hanger bar of claim 1, further comprising a pair of hooks formed in the body, each hook being configured for receiving a respective support rail to mount the hanger bar on the support rails, a first hook being formed proximate a first longitudinal end of the body and a second hook being formed proximate a second longitudinal end of the body opposite the first longitudinal end of the body.

11. The hanger bar of claim 1, wherein the body is formed from metal.

12. The hanger bar of claim 1, in combination with the hanging file folder.

13. A hanger bar for mounting a hanging file folder on a pair of support rails, the hanger bar comprising a body having a top, a bottom, and opposite longitudinal ends, a pair of hooks being formed in the bottom of the body, each hook being configured for receiving a respective support rail to mount the hanger bar on the support rails, a first hook being formed proximate a first longitudinal end of the body and a second hook being formed proximate a second longitudinal end of the body opposite the first longitudinal end of the body, portions of the hooks formed for engaging the support rails being blunt to facilitate sliding of the hanger bar along the support rails.

14. The hanger bar of claim 13, wherein the blunt portions are defined by a section of the body being bent out of plane with respect to another section of the body.

15. The hanger bar of claim 14, wherein the bent section extends along a curve.

16. The hanger bar of claim 13, wherein the body includes a first section having a length extending longitudinally across the body and a height extending from the top of the body toward the bottom of the body, a second section having a length extending longitudinally across the body and a height extending from the first section of the body toward the bottom of the body, and a third section having a length extending longitudinally across the body and a height extending from the second section of the body to the bottom of the body, each of the first, second, and third sections being angled with respect to a vertical axis when the body is positioned in a vertical orientation.

17. The hanger bar of claim 13, wherein the body is formed from metal.

18. The hanger bar of claim 13, in combination with the hanging file folder.

19. A hanger bar for mounting a hanging file folder on a pair of support rails, the hanger bar comprising a body having a top, a bottom, and opposite longitudinal ends, the body including a first section having a length extending longitudinally across the body and a height extending from the top of the body toward the bottom of the body, a second section having a length extending longitudinally across the body and a height extending from the first section of the body toward the bottom of the body, and a third section having a length extending longitudinally across the body and a height extending from the second section of the body to the bottom of the body, the first, second, and third sections each being planar.

20. The hanger bar of claim 19, wherein at least a portion of the planar second section extends continuously between the first and third sections such that the second section extends directly from the first section and the third section extends directly from the second section.
